(19) United States
(12) Patent Application Publication
(10) Pub. No.: US 2013/0340912 A1
(43) Pub. Date: Dec. 26, 2013

(54) TIRE WITH CHAFER COMPONENT

(71) Applicant: Junling Zhao, Hudson, OH (US)

(72) Inventor: Junling Zhao, Hudson, OH (US)

(21) Appl. No.: 13/529,169

(22) Filed: Jun. 21, 2012

(51) Int. Cl. B60C 15/06

(52) U.S. Cl. 152/543

(57) ABSTRACT

This invention relates to a tire having a chafer component, particularly tires expected to be used for heavy duty service in a sense of carrying heavy loads such as for example truck tires.

### FIELD OF THE INVENTION

This invention relates to a tire having a chafer component, particularly tires expected to be used for heavy duty service in a sense of carrying heavy loads such as for example truck tires.

### BACKGROUND OF THE INVENTION

The chafer is an important component of a pneumatic tire. It is an exposed tire component located in the bead region, or portion, of the tire which is used to seat the tire against a rigid wheel rim to form a tire/wheel assembly for an appropriate vehicle. Such chafer component of a tire against a tire wheel rim to form a tire/wheel assembly is well known to those having skill in such art.

A challenge is presented for providing a chafer component for a pneumatic tire intended to be used for heavy duty service composed of a rubber composition which promotes a reduction in hysteresis of the rubber composition, as evidenced by increase in its rebound physical property to thereby, in turn, promote a reduction in internal heat generation for the tire chafer component during the working of the tire during associated vehicular operation, particularly for heavy duty service.

In other words, lower hysteretic energy loss is typically evidenced by a higher rebound physical property of the rubber composition. Lower hysteretic energy low is predictive of a benefically lower rolling resistance of a tire having a chafer component of such rubber composition with a predictive consequently beneficial increased fuel economy for an associated vehicle.

To promote a higher rebound physical property of the rubber composition of the chafer component (e.g. to promote a lower hysteresis property of the rubber composition) a reduction in its reinforcing filler (e.g. carbon black) content may be used.

However, reducing the chafer component's hysteresis by reducing its carbon black content may also result in a reduction of one or more other desirable physical properties.

Accordingly, such challenge is undertaken to evaluate the feasibility of providing a specialized cis 1,4-polybutadiene-rich rubber composition (e.g. at least 55 phr of the specialized polybutadiene), together with an additional diene-based elastomer, particularly cis 1,4-polyisoprene rubber and particularly natural cis 1,4-polyisoprene rubber, for a tire chafer.

For the evaluation a specialized polybutadiene rubber was used for such purpose combined with a combination of reinforcement composed of both precipitated silica (amorphous synthetic silica) and rubber reinforcing carbon black for the rubber composition of the tire chafer component, all without containing cord reinforcement (e.g. exclusive of containing cord reinforcement).

In the description of this invention, the terms “compounded” rubber compositions and “compounds”; where used refer to the respective rubber compositions which have been compounded with appropriate compounding ingredients. The terms “rubber” and “elastomer” may be used interchangeably unless otherwise indicated. The amounts of materials are usually expressed in parts of material per 100 parts of rubber by weight (phr).

### DISCLOSURE AND PRACTICE OF THE INVENTION

In accordance with this invention, a tire is provided having a chafer composed of a rubber composition (e.g. rubber composition without containing cord reinforcement) which comprises, based upon parts by weight per 100 parts by weight rubber (phr):

(A) conjugated diene-based elastomers comprised of:
(1) about 55 to about 85, alternately from about 55 to about 65, and alternately from about 65 to about 80, phr of specialized cis 1,4-polybutadiene rubber, and correspondingly
(2) from about 45 to about 15, alternately from about 45 to abut 35 and alternately from about 35 to about 20, phr of at least one additional diene-based elastomer (in addition to the specialized polybutadiene), preferably cis 1,4-polyisoprene rubber;

(B) about 40 to about 110, alternately from about 50 to about 80, phr of reinforcing filler where said reinforcing filler is comprised of a combination of rubber reinforcing carbon black and amorphous synthetic silica (e.g. precipitated silica) comprised of:
(1) about 20 to about 60, alternately from about 30 to about 50, phr of rubber reinforcing carbon black, and correspondingly
(2) about 10 to about 80, alternately from about 20 to about 50, phr of precipitated silica, and

(C) silica coupling agent (for said precipitated silica) having a moiety reactive with hydroxyl groups (e.g. silanol groups) on said precipitated silica and another different moiety interactive with carbon-to-carbon double bonds of said conjugated diene-based elastomers;

wherein said specialized cis 1,4-polybutadiene elastomers are comprised of:
(1) a first specialized cis 1,4-polybutadiene elastomer having a microstructure comprised of about 94 to about 99 percent cis 1,4-isomeric units and a vinyl 1,2-content of less than one percent, alternately in a range of from about 0.2 to about 0.8 percent, a number average molecular weight (Mn) in a range of from about 180,000 to about 350,000 with less than 5, alternately about zero, percent, of the rubber having a weight average molecular weight (Mw) of less than 100,000; and a heterogeneity index (Mw/Mn) in a range of from about 1.4/1 to about 2/1, or
(2) a second specialized cis 1,4-polybutadiene having a microstructure comprised of about 94 to about 99 percent cis 1,4-isomeric units and a vinyl 1,2-content of less than one percent, alternately in a range of from about 0.2 to about 0.8 percent, a number average molecular weight (Mn) in a range of from about 150,000 to about 300,000 with less than 10, alternately from about 2 to about 10, percent, of the rubber having a weight average molecular weight (Mw) of less than 100,000; and a heterogeneity index (Mw/Mn) in a range of from about 1.4/1 to about 2/1, wherein the polybutadiene is sulfur dichloride, disulfur dichloride or thionylcloride treated, particularly disulfur dichloride treated, to cause a molecular weight jump (increase its molecular weight), which might sometimes be referred to a Mooney viscosity jump in the case of the uncured polybutadiene rubber).

In one embodiment, preferably, the specialized cis 1,4-polybutadiene rubber for said chafer component of said composite is said second specialized cis 1,4-polybutadiene rubber primarily because it is easier to process in its unvulcanized state even though it has been subjected to a Mooney viscosity jump.

In one embodiment, said reinforcing filler for said tire chafer component rubber composition is a combination of at least about 30 phr of rubber reinforcing carbon black (preferably at least to its percolation threshold content) and up to 50 phr precipitated silica (e.g. from 10 to 50 phr of precipitated silica), together with silica coupling agent.

The term “percolation threshold” content of the rubber reinforcing carbon black is the minimum content sufficient to provide electrical conductivity for the inherently electrically insulative rubber composition to enable conduction of electrical energy. A percolation threshold is somewhat dependent upon the particle size of the carbon black and the rubber composition surrounding the carbon black. It is often in a range of from about 30 to about 35 phr of rubber reinforcing carbon black. A discussion of electrical conductivity relative to “percolation threshold” may be found, for example, in a presentation entitled “Electrical Conduction in Carbon Black Composites” by Avrom Medalia, Rubber Division of the American Chemical Society, Los Angles, Calif., Apr. 23 through 25, 1985.

A significant aspect of this invention is, for a tire chafer component, to evaluate providing a rubber composition comprised of a specialized cis 1,4-polybutadiene-rich rubber composition (e.g. containing at least 55 phr, alternately at least 65 phr, of the specialized cis 1,4-polybutadiene rubber) based on an aforesaid specialized cis 1,4-polybutadiene rubber together with an additional diene-based rubber such as, for example, c is 1,4-polyisoprene rubber, where the rubber composition contains a combination of particulate reinforcement as precipitated silica and rubber reinforcing carbon black instead of solely rubber reinforcing carbon black.

This is considered herein to be a significant departure from past practice in the case of a tire chafer component.

Exemplary of rubber reinforcing carbon black for the rubber composition is, for example and not intended to be limiting, rubber reinforcing carbon black having an Iodine adsorption value (ASTM D1510) in a range of about 80 to about 145 g/kg together with a dibutylphthalate (DBP) value (ASTM D2414) in a range of about 50 to about 140, cc/100 g.

Representative of such rubber reinforcing carbon blacks are, for example, and not intended to be limiting, ASTM designated rubber reinforcing carbon blacks as exemplary N121 and N205 carbon blacks. Examples of various rubber reinforcing carbon blacks together with their Iodine number values and DBP values, may be found in The Vanderbilt Rubber Handbook, (1990), 13th edition, Pages 416 through 419.

Use of the rubber reinforcing carbon black(s) is considered herein to be important to promote good abrasion resistance and higher stiffness for the tire chafer component to promote resistance to rim scuffing as the tire/rim configuration is being worked.

Use of the inclusion of precipitated silica, in combination with the carbon black rubber reinforcement, is to evaluate promoting stiffness and low hysteresis for the chafer component when using the specialized cis 1,4-polybutadiene rich rubber composition with an endeavor to promote lower internal heat buildup within the chafer rubber component during the operational working of the tire.

In practice, the silica coupling agent for use with the precipitated silica (which contains hydroxyl groups on its surface) may be comprised of a bis(3-trialkoxysilylalkyl) polysulfide having an average of from 2 to 4, alternately an average of from about 2 to about 2.6 or an average of from about 3.4 to about 3.8, connecting sulfur atoms in its polysulfidic bridge or comprised of an alkoxyorganomercaptosilane. Such coupling agents are well known to those having skill in such art.

In practice, for the aforesaid first and second embodiments, it is envisioned that the specialized cis 1,4-polybutadiene elastomer may be a neodymium catalyst prepared polybutadiene which is prepared, for example, by polymerization of 1,3-polybutadiene monomer in an organic solvent solution in the presence of a catalyst system comprised of neodymium compound, an aluminum alkyl and an aluminum chloride delivering compound, and where the cis 1,4-polybutadiene polymer for the second embodiment is further coupled, for example, by treating the polymer product with, for example, a sulfur chloride such as, for example, disulfur dichloride (where such coupling is understood to promote the aforesaid less than 10 percent the rubber having an weight average molecular weight (Mw) of less than 100,000) as mentioned in U.S. Pat. No. 5,567,784, so long as it possesses the aforesaid microstructure, molecular weight and heterogeneity index properties.

Representative of neodymium compounds for the first and second embodiments might be, for example, neodymium neodecanoate, neodymium octanoate, neodymium carboxylate or neodymium versalate, particularly neodymium versalate which is mentioned in the aforesaid U.S. Pat. No. 5,567,784, as well as a combination of aluminum compounds to complete the neodymium catalyst such as, for example, a combination of diisobutylaluminum hydride (DIBAH) and ethylaluminium sesquichloride (EASC), which are understood to be appropriate for completing the neodymium catalyst, so long as specialized cis 1,4-polybutadiene has the aforesaid microstructure, molecular weight including the small amount of the elastomer having a molecular weight of less than 100,000, as well as its heterogenic index.

Therefore, the catalyst for preparation of said specialized polybutadiene elastomer of the aforesaid specialized cis 1,4-polybutadiene rubber is exclusive of cobalt and nickel based catalysts which may be used for preparation of other polybutadiene elastomers.

As previously indicated, for this evaluation, a purpose of inclusion of the specialized polybutadiene, combined with its inclusion of combination of precipitated silica and rubber reinforcing carbon black, with its aforesaid characterization of molecular weight, homogeneity index and Tg is to evaluate promoting higher rebound values for the rubber composition which is predictive of less internal heat generation, and therefore less temperature build-up for the rubber composition when it is being worked and predictive of better (lower) rolling resistance for a tire with a chafer component of such rubber composition which contains the specialized polybutadiene rubber. A further purpose is to promote greater abrasion resistance of the rubber composition to promote resistance to rigid rim scuffing and abrasion for the tire chafer in contact with the rim.

Representative of said specialized cis 1,4-polybutadiene rubber for use in this evaluation is, for example, CB25™ from Lanxess Company. While the technical aspect may not be fully understood, it is a feature of this invention that the specialized cis 1,4-polybutadiene rubber with its required characterized combination of isomeric content, molecular weights and heterogeneity index, is thereby differentiated from other cis 1,4-polybutadiene rubbers largely because is the product of organic solvent solution polymerization of 1,3-butadiene monomer in the presence of the neodymium based catalyst instead of lithium, cobalt or nickel based polymerization catalysts and, also, as previously discussed, that it is understood that the polymer product is coupled with a sulfur chloride, for example with a disulfur dichloride.

In the practice of this invention, as previously indicated, use of the specialized cis 1,4-polybutadiene rubber in a silica reinforcement-containing rubber composition, together with a coupling agent for the silica is considered herein to be important in order to optimize resistance to the rubber composition's abrasion (predictive resistance to rim scuffing, namely scuffing of the rubber against the rigid metal rim) and to promote a relatively low hysteresis (e.g. reduced internal heat build up with accompanying temperature increase), particularly as compared to such rubber composition which contains rubber reinforcing carbon black for reinforcement of the rubber composition without the precipitated silica rubber reinforcement, as well as promoting suitable tear strength (tear resistance).

In practice, as indicated, various additional conjugated diene-based elastomers (in addition to and in combination with said specialized cis 1,4-polybutadiene rubber) may be used for the chafer rubber composition where appropriate.

Representative of such additional elastomers are polymers comprised of at least one of isoprene and 1,3-butadiene and copolymers of styrene and at least one of isoprene and 1,3-butadiene.

Representative examples of such additional elastomers are, for example, comprised of cis 1,4-polyisoprene rubber (natural or synthetic rubber), cis 1,4-polybutadiene rubber, styrene/butadiene copolymer rubber, styrene/isoprene/butadiene terpolymer rubber and isoprene/butadiene rubber. Usually, such additional elastomer is a cis 1,4-polyisoprene rubber.

The silica couplers (sometimes referred to as silica coupling agents) for the precipitated silica in the chafer rubber composition may be, for example,

(A) a bis-(3-trialkoxysilylalkyl) polysulfide such as, for example, a bis-(3-triethoxysilylpropyl) polysulfide, having an average of from 2 to about 4 and more preferably an average of from 2 to about 2.6 or from about 3.4 to about 4, connecting sulfur atoms in its polysulfidic bridge, or

(B) an organoalkoxymercaptosilane.

The bis(3-trialkoxysilylalkyl) polysulfide may, for example, be comprised of a bis-(3-triethoxysilylpropyl) polysulfide.

Representative examples of various organoalkoxymercaptosilanes may be, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane.

The coupling agent may, for example, be added directly to the elastomer mixture or may be added as a composite of precipitated silica and such coupling agent formed by pretreating a precipitated silica therewith.

The precipitated silica for the reinforcing filler is a synthetic amorphous silica such as, for example, those obtained by the acidification of a soluble silicate (e.g., sodium silicate or a co-precipitation of a silicate and an aluminate). Such precipitated silicas are, in general, well known to those having skill in such art.

The BET surface area of the synthetic silica (precipitated silica), as measured using nitrogen gas, may, for example, be in a range of about 50 to about 300, alternatively about 120 to about 200, square meters per gram.

The silica may also have a dibutylphthalate (DBP) absorption value in a range of, for example, about 100 to about 400, and usually about 150 to about 300 cc/g.

Various commercially available synthetic silicas, particularly precipitated silicas, may be considered for use in this invention such as, for example, only and without limitation, silicas commercially available from PPG Industries under the Hi-Sil trademark with designations 210, 243, etc; silicas available from Rhodia, with designations of Zeosil 1165 MP and Zeosil 165GR and silicas available from Degussa AG with designations VN2 and VN3, 3770GR, and from Huber as Zeopol 8745.

### BRIEF DESCRIPTION OF THE DRAWING

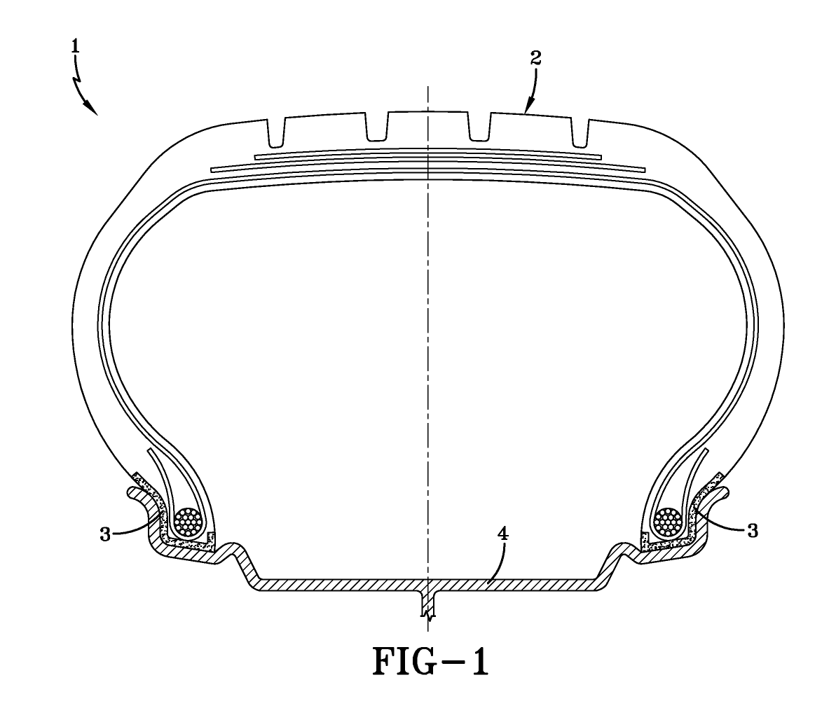

A Drawing is provided in a form of FIG. 1, namely FIG. 1, of a tire/rim assembly composed of a tire seated against a rigid metal wheel rim.

### THE DRAWING

In FIG. 1, a tire/wheel assembly is shown in a form of a cross section of a tire/rim assembly (1) depicted as a cross section of a tire (2) mounted on a rigid metal tire wheel rim (4).

The tire (2) has a rim-contacting rubber chafer component (3). For the purposes of this drawing, the tire (2) with its chafer component (3) is depicted as being mounted on the rigid tire wheel rim (4) to form the tire/rim assembly (1) with the tire chafer (3) seated, or fitted, against the rigid tire wheel rim (4) to thereby seal the tire (2) against the rigid rim (4) to both restrict air leakage from the internal tire cavity to the atmosphere and to form a direct connection of the tire (2) to the vehicular wheel rim (4) through the tire's chafer component (3) to thereby enable transmission of vehicular driving power to the tire (2) itself and thence to the tire tread running surface and ground.

It is a feature of this invention that the chafer component (3) of the tire (2) is of a rubber composition which is resistant to abrasion against the rigid rim (4), (resistant to rim scuffing of the chafer component) and, also, promotes a relatively low internal heat generation during use and working of the tire (2) as a result of its relatively low hysteresis promoted by containing the aforesaid specialized polybutadiene rubber.

It is readily understood by those having skill in the art that the rubber of the chafer would be compounded with conventional compounding ingredients including the aforesaid reinforcing fillers such as carbon black and precipitated silica, as hereinbefore mentioned, in combination with a silica coupling agent, as well as antidegradant(s), processing oil, as appropriate, fatty acid primarily comprised of, for example, stearic, palmitic and oleic acids which may also possibly contain linolenic acid, zinc oxide, sulfur and one or more sulfur vulcanization accelerator(s).

Processing aids may be used, if appropriate, for example, waxes such as microcrystalline and paraffinic waxes, in a range, for example, of about 1 to 5 phr or about 1 to about 3 phr; and resins may be used if appropriate, usually as tackifiers, such as, for example, synthetic hydrocarbon and natural resins in a range of, for example, about 1 to 5 phr or about 1 to about 3 phr. A curative might be classified as sulfur together with one or more sulfur cure accelerator(s). In a sulfur and accelerator(s) curative, the amount of sulfur used may be, for example, from about 0.5 to about 5 phr, more usually in a range of about 0.5 to about 3 phr; and the accelerator(s), often of the sulfenamide type, is (are) used in a range of about 0.5 to about 5 phr, often in a range of about 1 to about 2 phr. The ingredients, including the elastomers but exclusive of sulfur and accelerator curatives, are normally first mixed together in a series of at least two sequential mixing stages, although sometimes one mixing stage might be used, to a temperature in a range of, for example, about 145° C. to about 185° C., and such mixing stages are typically referred to as non-productive mixing stages. Thereafter, the sulfur and accelerators, and possibly one or more retarders and possibly one or more antidegradants, are mixed therewith to a temperature of, for example, about 90° C. to about 120° C. and is typically referred as a productive mix stage. Such mixing procedure is well known to those having skill in such art.

After mixing, the compounded rubber can be fabricated such as, for example, by extrusion through a suitable die to form a tire chafer component. The tire chafer is then typically built as a component of a sulfur curable tire carcass and the assembly thereof cured in a suitable mold under conditions of elevated temperature and pressure by methods well-known to those having skill in such art.

The invention may be better understood by reference to the following example in which the parts and percentages are by weight unless otherwise indicated.

### EXAMPLE I

### Tire Chafer Component

Rubber compositions, containing a combination of carbon black and precipitated silica reinforcement fillers, were prepared to evaluate replacement of a significant amount of natural rubber (natural cis 1,4-polyisoprene rubber) with various neodymium as well as nickel catalysis prepared cis 1,4-polybutadiene elastomers for a tire chafer.

Rubber compositions are referred in this Example as rubber Samples E, F, G and H.

Rubber Sample E is a Control rubber Sample based on natural rubber with a cis 1,4-polybutadiene rubber prepared by nickel based catalysis which contains a significant low molecular weight fraction, namely more than 20 percent of the elastomer having a low weight average molecular weight (Mw) of less than 100,000.

Rubber Samples F, G and H are Experimental rubber Samples based upon specialized cis 1,4-polybutadiene elastomers prepared by neodymium based catalysis used with a minor amount of the natural rubber.

The basic rubber composition formulation is shown in Table 1 and the ingredients are expressed in parts by weight per 100 parts rubber (phr) unless otherwise indicated.

The rubber compositions may be prepared by mixing the elastomers(s) without sulfur and sulfur cure accelerators in a first non-productive mixing stage (NP-1) in an internal rubber mixer for about 4 minutes to a temperature of about 160° C. If desired, the rubber mixture may then mixed in a second non-productive mixing stage (NP-2) in an internal rubber mixer for about 4 minutes to a temperature of about 160° C. without adding additional ingredients. The resulting rubber mixture may then mixed in a productive mixing stage (PR) in an internal rubber mixer with sulfur and sulfur cure accelerator(s) for about 2 minutes to a temperature of about 110° C. The rubber composition may then sheeted out and cooled to below 50° C. between each of the non-productive mixing steps and prior to the productive mixing step. Such rubber mixing procedure is well known to those having skill in such art.

TABLE 1

| | Parts (phr) | | | |
|---|---|---|---|---|
| | Control | Experimental | | |
| | E | F | G | H |
| Non-Productive Mixing Step (NP), 160° C. | | | | |
| Mixed to 160° C. | | | | |
| Natural cis 1,4-polyisoprene rubber | 30 | 25 | 20 | 20 |
| (SMR20) | | | | |
| Cis 1,4-polybutadiene rubber (nickel | 70 | 0 | 0 | 0 |
| catalysis)¹ | | | | |
| Second specialized cis 1,4-polybutadiene | 0 | 75 | 80 | 0 |
| rubber² | | | | |
| First specialized cis 1,4-polybutadiene | 0 | 0 | 0 | 80 |
| rubber³ | | | | |
| Carbon black, rubber reinforcing (N220)⁴ | 70 | 0 | 0 | 0 |
| Carbon black, rubber reinforcing (N121)⁵ | 0 | 32 | 35 | 35 |
| Silica, precipitated⁶ | 0 | 32 | 32 | 32 |
| Silica coupling agent, without carbon black | 0 | 0 | 3.2 | 3.2 |
| carrier⁷ | | | | |
| Silica coupling agent, as a carbon black | 0 | 6.4 | 0 | 0 |
| composite⁸ | | | | |
| Wax, microcrystalline and paraffin | 1.5 | 1.5 | 1.5 | 1.5 |
| Fatty acid⁹ | 2 | 2 | 2 | 2 |
| Antioxidants | 4.8 | 4.8 | 4.8 | 4.8 |
| Zinc oxide | 3 | 3 | 3 | 3 |
| Rubber processing oil and hydrocarbon | 5 | 8 | 8 | 8 |
| resin | | | | |
| Productive Mixing Step (PR), Mixed | | | | |
| to 110° C. | | | | |
| Sulfur | 1.5 | 1.8 | 1.5 | 1.5 |
| Sulfur cure accelerator(s)¹⁰ | 2 | 2 | 1.6 | 1.6 |

¹Nickel based catalysis prepared cis 1,3-butadiene monomer to form a 1,4-polybutadiene rubber as BUD4001 ™ from The Goodyear Tire & Rubber Company, having a Tg or about −103° C., a microstructure comprised of about 97 percent cis 1,4-isometric units and vinyl 1,2-content of about 1.5 percent, a number average molecular weight (Mn) of about 150,000 with a significant portion of the elastomer, namely about 23 percent, having a weight average molecular weight (Mw) of less than 100,000 and a heterogeneity index (Mw/Mn) of about 3 prepared by polymerizing 1,3-butadiene monomer in an organic solution with a nickel based catalyst. .
²Second specialized cis 1,4-polybutadiene rubber, as CB25 ™ from the Lanxess Company having a Tg of about −107° C., solution polymerized 1,3-butadiene monomer comprised of about 97 percent cis 1,4-isomeric units and vinyl 1,2-content of about 0.5 percent, a number average molecular weight (Mn) of about 240,000 with only a very small portion of the elastomer, namely about 3 percent, having an weight average molecular weight (Mw) of less than 100,000 and heterogeneity index (Mw/Mn) of about 1.8/1 prepared by polymerizing 1,3-butadiene monomer in a organic solvent solution in the presence of a neodymium based catalyst where the polymer has been coupled in the presence of a sulfur chloride such as, for example disulfur dichloride.
³First specialized cis 1,4-polybutadiene rubber, as CB22 ™ from the Lanxess Company having a Tg of about −108° C., comprised of about 96 percent cis 1,4-isomeric units and vinyl 1,2-content about 0.4 percent, a number average molecular weight (Mn) of about 292,000 with only a minimal amount, if any, of the elastomer, namely about zero percent, having an weight average molecular weight (Mw) of less than 100,000 and a heterogeneity index (Mw/Mn) of about 1.6/1 prepared by polymerizing 1,3-butadiene monomer in a organic solvent solution in the presence of a neodymium based catalyst.
⁴Rubber reinforcing carbon black as N220, an ASTM designation
⁵Rubber reinforcing carbon black as N121, an ASTM designation
⁶Precipitated silica as Zeosil ™ Z1165 MP from the Rhodia Company
⁷Coupling agent for the silica comprised of bis(3-triethoxysilylpropyl) polysulfide having an average of from about 2 to about 2.6 connecting sulfur atoms as Si266 ™ from Evonik Degussa
⁸Composite of 50/50 coupling agent for the silica and carbon black carrier, where the coupling agent for the silica is comprised of bis(3-triethoxysilylpropyl) polysulfide having an average of from about 2 to about 2.6 connecting sulfur atoms as Si266 ™ from Evonik Degussa presented in the Table as a composite with the carbon black carrier.
⁹Mixture comprised of stearic, palmitic and oleic acids
¹⁰Sulfenamide and diphenyl guanidine sulfur cure accelerators

The following Table 2 represents the uncured and cured behavior and various physical properties of the rubber compositions based upon the basic formulation of Table 3, and reported as Control rubber Sample E and Experimental rubber Samples F, G and H.

TABLE 2

| | Control (phr) | Experimental (phr) | | |
|---|---|---|---|---|
| | E | F | G | H |
| Natural rubber | 30 | 25 | 20 | 20 |
| Cis 1,4-polybutadiene rubber (nickel catalysis) | 70 | 0 | 0 | 0 |
| Second specialized polybutadiene, namely CB25 ™ | 0 | 75 | 80 | 0 |
| First specialized polybutadiene, namely CB22 ™ | 0 | 0 | 0 | 80 |
| RPA test | | | | |
| Uncured dynamic storage modulus G' (KPa) | 350 | 308 | 355 | 531 |
| at 15% strain, 0.83 Hz, 100° C. | | | | |
| Dynamic storage modulus G' (MPa) at 10% | 2.14 | 2.36 | 1.9 | 2.09 |
| strain, 1 Hz, 100° C. | | | | |
| Tan delta at 10% strain, 1 Hz, 100° C. | 0.182 | 0.154 | 0.164 | 0.161 |
| MDR test; 60 minutes at 150° C. | | | | |
| Maximum torque (dN-m) | 31.4 | 30.9 | 24.9 | 27.4 |
| Minimum torque (dN-m) | 5.73 | 4.87 | 5.34 | 7.53 |
| T90 (minutes) | 9.97 | 11.7 | 12.8 | 12.3 |
| Stress-strain | | | | |
| Tensile strength (MPa) | 15.7 | 18.1 | 19.2 | 19.6 |
| Elongation at break (%) | 318 | 443 | 542 | 529 |
| 100% modulus, ring, (MPa) | 3.04 | 2.7 | 2.01 | 2.05 |
| 300% modulus, ring, (MPa) | 16.6 | 12.2 | 9.2 | 9.5 |
| Rebound (Zwick) | | | | |
| 23° C. | 43 | 50 | 50 | 51 |
| 100° C. | 58 | 62 | 59 | 60 |
| Shore A Hardness | | | | |
| 23° C. | 76 | 76 | 70 | 70 |
| 100° C. | 70 | 69 | 64 | 64 |
| Tear Strength, N | | | | |
| At 95° C. | 68 | 87 | 144 | 150 |
| Aged 7 days/70° C. at 95° C. | 55 | 74 | 141 | 121 |
| DIN Abrasion⁵ (loss of rubber relative to a control) | | | | |
| 23° C. (lower loss is better abrasion resistance) | 60 | 44 | 37 | 31 |

⁵D1N53516

From Table 2 it can be seen that, as compared to Control rubber Sample E, all of Experimental rubber Samples F, G and H using the specialized cis 1,4-polybutadiene elastomers prepared by the neodymium based catalysis of 1,3-butadiene monomer exhibited:

(1) increased ultimate tensile strength and elongation,

(2) combination of improved (increased) 23° C. and 100° C. rebound values as well as improved (reduced) tan delta property values, together indicating a better (improved) hysteresis property and thereby predictive beneficially reduced internal heat generation during working of the rubber composition,

(3) significantly increased tear strength,

(4) significantly improved abrasion resistance (resistance to abrasion).

However, it can also be seen for rubber Sample H, which used the first specialized polybutadiene rubber, namely the CB22™, for its primary elastomer, processing of the uncured rubber composition exhibited a significantly increased storage modulus (G′) of 531 MPa for the uncured rubber composition thereby indicating significantly increased rubber processing difficulty than all of Control rubber Sample E and Experimental rubber Samples F and G.

Therefore, it is concluded that the evaluation of the rubber compositions, containing a combination of carbon black and precipitated silica reinforcement fillers together with silica coupling agent, demonstrated that the rubber composition containing the second specialized polybutadiene rubber, namely the C25™ polybutadiene, together with both the precipitated silica and rubber reinforcing carbon black reinforcing filler, yielded the better beneficial balance of both cured and uncured rubber properties for use as a chafer component which contains a combination of both carbon black and precipitated silica reinforcement fillers, for a tire intended for heavy duty use.

What it claimed is:

1. A pneumatic tire having a composite of a chafer component, where said chafer component is a rubber composition containing specialized cis 1,4-polybutadiene elastomer comprised of, based on parts by weight per 100 parts by weight of rubber (phr):
(A) 100 phr of conjugated diene-based elastomers comprised of:
(1) specialized cis 1,4-polybutadiene elastomer, and
(2) additional conjugated diene based elastomer comprised of at least one of polymers of at least one of isoprene and 1,3-butadiene and copolymers of styrene and at least one of isoprene and 1,3-butadiene, and
(B) rubber reinforcing filler comprised of a combination of rubber reinforcing carbon black and precipitated silica, and:
(C) coupling agent for said precipitated silica having a moiety reactive with hydroxyl groups on said precipitated silica and another different moiety interactive with said elastomer(s);
wherein said specialized cis 1,4-polybutadiene elastomers are comprised of:
(1) a first specialized cis 1,4-polybutadiene elastomer having a microstructure comprised of about 94 to about 99 percent cis 1,4-isomeric units and a vinyl 1,2-content of less than one percent, alternately in a range of from about 0.2 to about 0.8 percent, a number average molecular weight (Mn) in a range of from about 180,000 to about 350,000 with less than 5, alternately about zero, percent, of the rubber having a weight average molecular weight (Mw) of less than 100,000; and a heterogeneity index (Mw/Mn) in a range of from about 1.4/1 to about 2/1, or
(2) a second specialized cis 1,4-polybutadiene having a microstructure comprised of about 94 to about 99 percent cis 1,4-isomeric units and a vinyl 1,2-content of less than one percent, alternately in a range of from about 0.2 to about 0.8 percent, a number average molecular weight (Mn) in a range of from about 150,000 to about 300,000 with less than 10, alternately from about 2 to about 10, percent, of the rubber having a weight average molecular weight (Mw) of less than 100,000; and a heterogeneity index (Mw/Mn) in a range of from about 1.4/1 to about 2/1, wherein the polybutadiene is sulfur dichloride, disulfur dichloride or thionylcloride treated to cause a molecular weight jump.

2. The tire of claim 1 where, for its chafer component, the specialized cis 1,4-polybutadiene rubber for said chafer component of said composite is said second specialized cis 1,4-polybutadiene rubber.

3. The tire of claim 1 where, for its chafer component, the specialized cis 1,4-polybutadiene rubber for said chafer component of said composite is said first specialized cis 1,4-polybutadiene rubber.

4. The tire of claim 1 where, for its chafer component, said reinforcing filler is a combination of at least about 30 phr of rubber reinforcing carbon black and up to 50 phr precipitated silica together with silica coupling agent.

5. The tire of claim 4 wherein said rubber reinforcing carbon black content is at least its percolation threshold content.

6. The tire of claim 4 wherein said precipitated silica content is in a range of from about 10 to about 50 phr of precipitated silica.

7. The tire of claim 2 where, for its chafer component, said reinforcing filler is a combination of at least about 30 phr of rubber reinforcing carbon black and up to 50 phr precipitated silica together with silica coupling agent.

8. The tire of claim 7 wherein said precipitated silica content is in a range of from about 10 to about 50 phr of precipitated silica.

9. The tire of claim 7 wherein said rubber reinforcing carbon black content is at least its percolation threshold content.

10. The tire of claim 3 where, for its chafer component, said reinforcing filler is a combination of at least about 30 phr of rubber reinforcing carbon black and up to 50 phr precipitated silica together with silica coupling agent.

11. The tire of claim 10 wherein said precipitated silica content is in a range of from about 10 to about 50 phr of precipitated silica.

12. The tire of claim 10 wherein said rubber reinforcing carbon black content is at least its percolation threshold content.

13. The tire of claim 1 wherein said specialized cis 1,4-polybutadiene rubber is a product of polymerization of cis 1,3 butadiene monomer in the presence of neodymium based catalyst.

14. The tire of claim 1 wherein said specialized cis 1,4-polybutadiene rubber is said second specialized cis 1,4-polybutadiene and is a product of polymerization of cis 1,3-butadiene monomer in the presence of a combination of neodymium compound comprised of neodymium carboxylate and alkyl aluminum compound and wherein said specialized cis 1,4-polybutadiene is treated with at least one of sulfur chloride and disulfur dichloride.

15. The tire of claim 1 wherein said additional diene-based elastomers are comprised of at least one of cis 1,4-polyisoprene rubber and styrene/butadiene rubber.

16. The tire of claim 2 wherein said additional diene-based elastomers are comprised of at least one of cis 1,4-polyisoprene rubber and styrene/butadiene rubber.

17. The tire of claim 3 wherein said additional diene-based elastomers are comprised of at least one of cis 1,4-polyisoprene rubber and styrene/butadiene rubber.

18. The tire of claim 7 wherein said additional diene-based elastomers are comprised of at least one of cis 1,4-polyisoprene rubber and styrene/butadiene rubber.

19. The tire of claim 10 wherein said additional diene-based elastomers are comprised of at least one of cis 1,4-polyisoprene rubber and styrene/butadiene rubber.
